(19) United States
(12) Patent Application Publication
(10) Pub. No.: US 2012/0038124 A1
(43) Pub. Date: Feb. 16, 2012

(54) JOGGING STROLLER

(76) Inventor: Milton A. Newton, JR., Thermal/Desert Shores, CA (US)

(21) Appl. No.: 13/205,468

(22) Filed: Aug. 8, 2011

Related U.S. Application Data
(60) Provisional application No. 61/372,597, filed on Aug. 11, 2010.

(51) Int. Cl. B62B 11/00; F16D 1/12

(52) U.S. Cl. 280/47.38; 403/122

(57) ABSTRACT

The present invention relates to strollers for infants and young children, and more particularly to a stroller for hands-free use, such as while jogging. In one embodiment, a jogging stroller includes a stroller for a baby carriage or carseat, and a drawbar extending forward from the front of the stroller. A harness at the front of the drawbar attaches to the user's waist, enabling the user to pull the stroller forward hands-free. The drawbar is connected at one end to the waist harness by a joint that pivots about at least two axes. The drawbar is connected at the opposite end to the front of the stroller by a joint that pivots about one or two axes. These joints give the user the flexibility to move in various directions with the rigid drawbar drawing the stroller behind. The stroller includes a frame that is sized and shaped to receive various different carseats or other baby seats or carriers.

### CROSS-REFERENCE TO RELATED APPLICATION(S)

This application claims priority to and the benefit of U.S. Provisional Application No. 61/372,597, filed Aug. 11, 2010, the entire content of which is expressly incorporated herein by reference.

### FIELD OF THE INVENTION

The present invention relates to strollers for infants and young children, and more particularly to a stroller for hands-free use, such as while jogging.

### BACKGROUND

Various strollers or carriages have been designed to carry a baby or small child, with the adult typically pushing the stroller from the rear. However, many such strollers are difficult to operate, such as requiring one or both hands to push or pull the stroller, and requiring customized or tailored seats (such as a specific carseat) for the baby. These strollers can be difficult to operate hands-free, while jogging, and/or with multiple different carseats. Accordingly there is still a need for a more compatible stroller that can be operated hands-free.

### SUMMARY

The present invention relates to strollers for infants and young children, and more particularly to a stroller for hands-free use, such as while jogging.

In one embodiment, a jogging stroller includes a stroller for a baby carriage or carseat, and a drawbar extending forward from the front of the stroller. A harness at the front of the drawbar attaches to the user's waist, enabling the user to pull the stroller forward hands-free. The drawbar is connected at one end to the waist harness by a joint that pivots about at least two axes. The drawbar is connected at the opposite end to the front of the stroller by a joint that pivots about one or two axes. These joints give the user the flexibility to move in various directions with the rigid drawbar drawing the stroller behind. The stroller includes a frame that is sized and shaped to receive various different carseats or other baby seats or carriers. The jogging stroller is thus compatible with various products, and is hands-free and easy to use.

In one embodiment, a jogging stroller includes a stroller having a frame dimensioned to receive a baby carrier or carseat, a drawbar mounted to the stroller by a first joint allowing at least one axis of rotation, and a harness mounted to a front end of the drawbar by a second joint allowing at least two axes of rotation.

In one embodiment, a jogging stroller includes a frame dimensioned to receive a baby carrier or carseat, first and second rear wheels supporting the frame, a front wheel coupled to the frame by a vertical bearing allowing rotation of the front wheel with respect to the frame about a vertical axis, a drawbar coupled to the frame by a hinge allowing rotation of the drawbar with respect to the frame about a horizontal axis, and a harness mounted to a front end of the drawbar by a swivel joint.

### BRIEF DESCRIPTION OF THE DRAWINGS

FIG. 1 is a side view of a jogging stroller in use, according to an embodiment of the invention.

FIG. 2 is a partial side view of a draw bar component of a jogging stroller according to an embodiment of the invention.

FIG. 3 is a partial perspective view of a jogging stroller according to an embodiment of the invention.

FIG. 4 is a partial front perspective view of the jogging stroller of FIG. 3.

FIG. 5 is a rear perspective view of a waist harness for a jogging stroller according to an embodiment of the invention.

FIG. 6 is a fragmentary side perspective view of a jogging stroller according to another embodiment of the invention.

FIG. 7 is a side view of a jogging stroller according to an embodiment of the invention.

FIG. 8 shows front and side views of a draw bar component of a jogging stroller according to an embodiment of the invention.

FIG. 9 is an exploded view of ball and socket joint for use with the waist harness of a jogging stroller according to an embodiment of the invention.

FIG. 10 is an exploded view of a hinge assembly for use with a jogging stroller according to an embodiment of the invention.

FIG. 11 is a front and side view of a back brace for use with a jogging stroller according to an embodiment of the invention.

### DETAILED DESCRIPTION

The present invention relates to strollers for infants and young children, and more particularly to a stroller for hands-free use, such as while jogging. In one embodiment, a jogging stroller includes a stroller for a baby carriage or carseat, and a drawbar extending forward from the front wheel of the stroller. A harness at the front of the drawbar attaches to the user's waist, enabling the user to pull the stroller forward hands-free. The drawbar is connected at one end to the waist harness by a joint that pivots about at least two axes. The drawbar is connected at the opposite end to the front wheel of the stroller by a joint that pivots about at least one or at least two axes. These joints give the user the flexibility to move in various directions with the rigid drawbar drawing the stroller behind. The stroller includes a frame that is sized and shaped to receive various different carseats or other baby seats or carriers. The jogging stroller is thus compatible with various products, and is hands-free and easy to use.

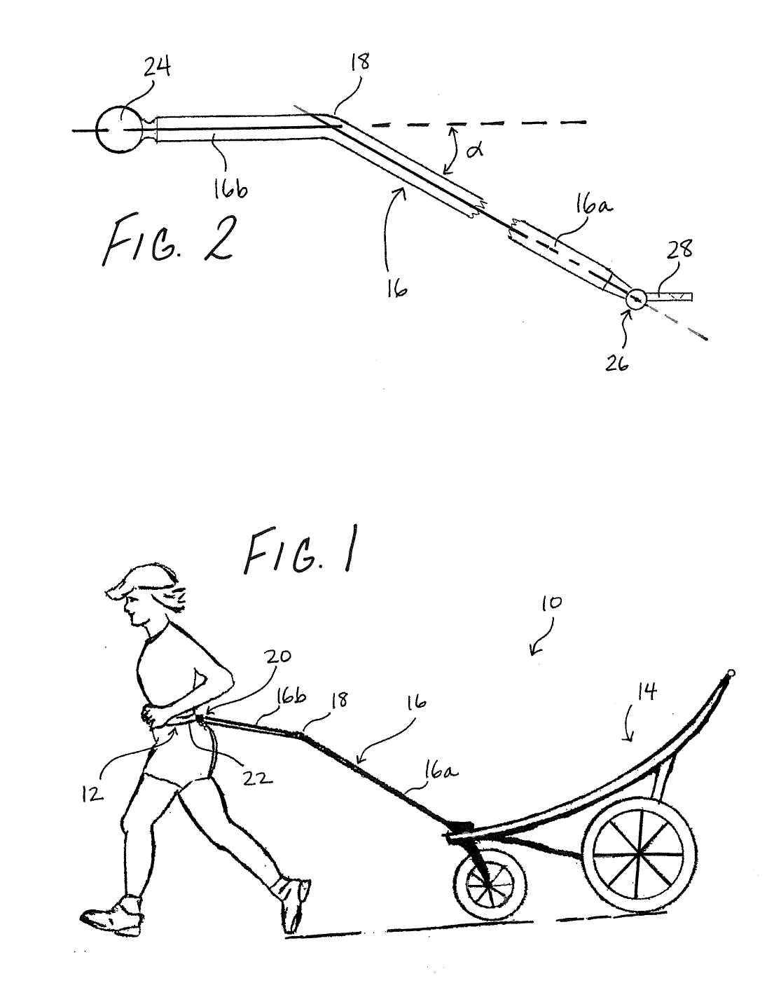

An embodiment of a jogging stroller 10 is shown in FIG. 1. The jogging stroller 10 includes a harness 12 for the adult user, a baby stroller 14, and a drawbar 16 connecting the harness to the baby stroller. The drawbar 16 extends up from the stroller 14 and bends at an elbow 18 toward the adult user. The drawbar 16 attaches to the harness 12 at a swivel joint 20, which is attached to a belt or strap 22 that is secured around the user's waist.

An embodiment of the drawbar 16 is shown in FIG. 2. The elbow 18 of the drawbar 16 forms a corner that bends the bar at an angle a, forming two portions 16a, 16b of the drawbar. The first portion 16a extends up from the stroller to the elbow 18, and the second portion 16b extends from the elbow 18 to the user at a more horizontal level. The lengths of the portions 16a, 16b and the size of the angle a can be chosen based on the size of the stroller and the expected height of the user. Depending on the height of the user, the second portion 16b may be horizontal or substantially horizontal. In one embodiment, the angle a is about 30 degrees. In one embodiment, the draw bar 16 is about 5 feet in length. In other embodiments the draw bar 16 can vary in length from between about 3.5 feet to about 6 feet. The length of the draw bar is chosen based on the user's stride, to provide sufficient clearance between the adult user and the stroller.

The drawbar 16 includes a ball 24 at a first end of the drawbar and a hinge 26 at a second opposite end. The ball 24 forms part of the swivel joint 20 that connects the drawbar 16 to the harness 12. The hinge 26 includes a hinge plate 28 that is mounted to the stroller to attach the drawbar 16 to the stroller, as described more fully below.

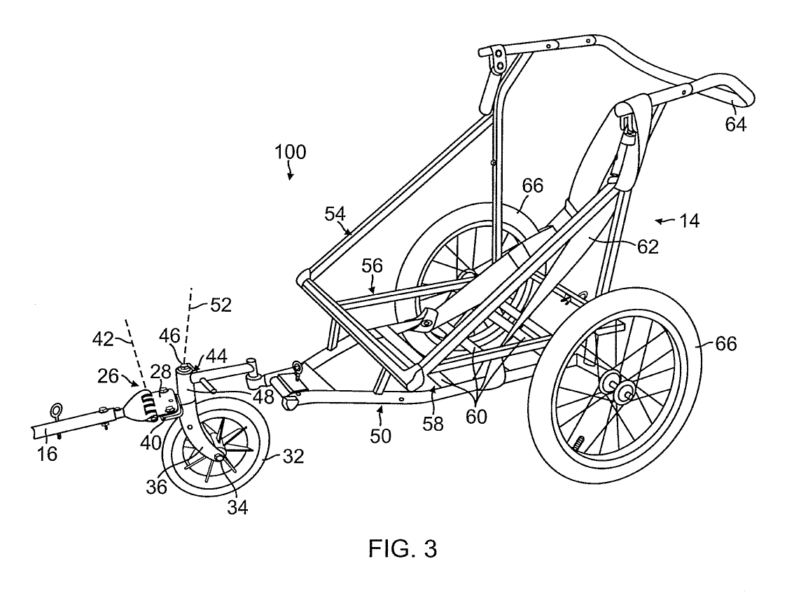

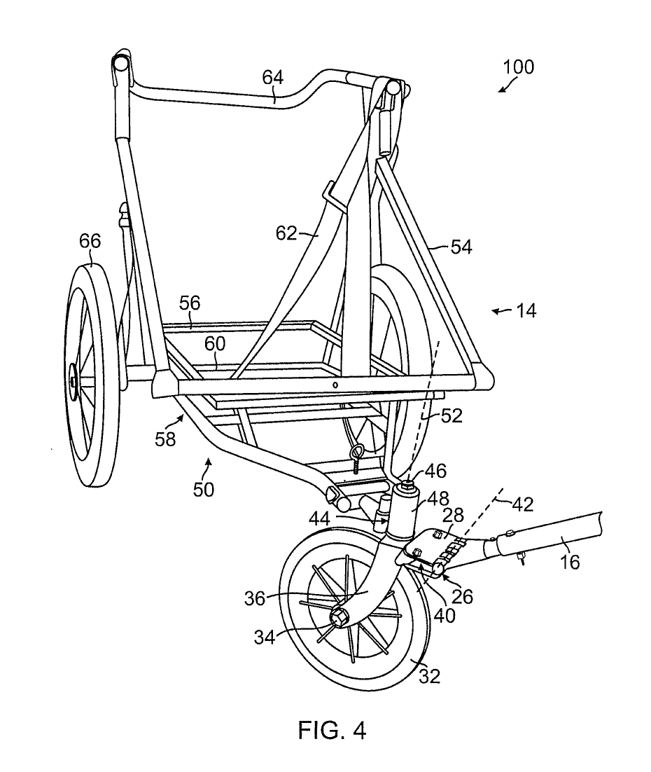

An embodiment of a jogging stroller 100 is shown in FIGS. 3-4. The jogging stroller 100 includes a drawbar 16 and a baby stroller 14 with a front wheel 32. In this embodiment, the drawbar 16 is mounted to the stroller 14 by two different joints, enabling the drawbar to pivot about two different axes with respect to the stroller 14. The two-axis pivoting attachment between the drawbar and stroller enables the adult user to move with flexibility, without being constrained by the rigid drawbar 16, and while still passing movement via the drawbar to the stroller to draw the stroller behind the user.

The first joint connecting the drawbar 16 to the stroller 14 is a hinge joint 26. The hinge joint 26 includes a hinge plate 28 that is fixed to the front wheel 32 of the stroller. The front wheel 32 includes a wheel axis 34 and a yoke 36 mounted on the axis 34. In the embodiment shown, the hinge plate 28 is fixed to the yoke 36 such as by welding, gluing, or using fasteners to attach the plate 28 to the yoke 36 at the overlap area 40. This weld (or other means of attachment, such as bolts, screws, clamps, glue, or adhesive) rigidly connects the drawbar 16 to the stroller 14 so that movement from the adult user is passed to the stroller, to draw the stroller behind the user. The hinge 26 enables the drawbar 16 to pivot with respect to the yoke 36 and the stroller 14 about a horizontal axis 42. Thus, for example, if the user moves up and down while running or jogging, the drawbar 16 can pivot up and down about this horizontal axis 42 without bouncing the stroller 14 up and down as well. The hinge joint 26 provides a smoother ride for the stroller 14 while giving the adult user the flexibility to move up and down.

Referring again to FIGS. 3-4, the second joint connecting the drawbar 16 to the stroller 14 is a vertical bearing 44. The vertical bearing 44 includes a pin 46 inside a sleeve 48. The pin 46 is connected to the yoke 36 and extends vertically up from the yoke 36. The sleeve 48 is attached to the front end of the stroller frame 50. The sleeve 48 fits over the pin 46 and allows the pin 46 to rotate inside the sleeve about a vertical axis 52. This vertical bearing 44 thus enables the adult user to move to the right and left, from side to side, while smoothly steering the stroller 14 behind the user. When the user moves to the right or left, the drawbar 16 will move with the user, moving the hinge plate 28 and yoke and thereby steering the front wheel 32. When the front wheel turns to the right or left, the pin 46 rotates within the sleeve 48. This freedom of rotation about the vertical axis 52 enables the user to smoothly turn to the right or left with the stroller following behind. The jogging stroller 100 is shown with the front wheel 32 turned in FIG. 4, to demonstrate the drawbar steering the stroller. The drawbar allows the stroller to be operated by front draw propulsion. The connection of the drawbar to the stroller at the front wheel provides complete steering control and enables the user to propel the stroller from the front while keeping the user's hands free.

In another embodiment, the joint connecting the drawbar 16 to the stroller 14 is a universal joint that allows rotation about two axes.

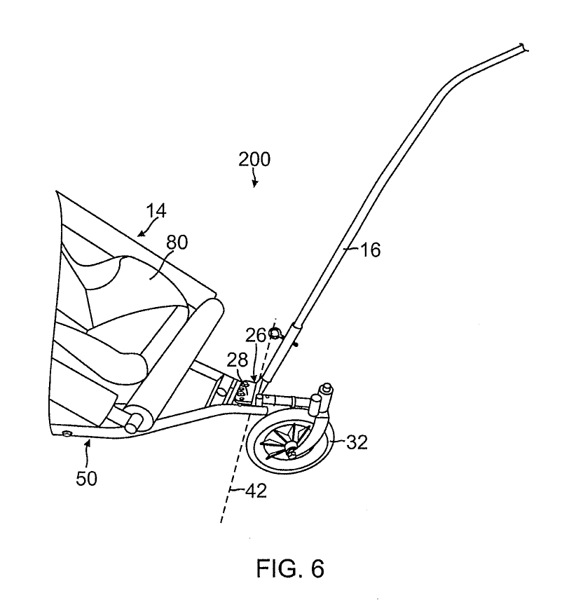

FIGS. 3-4 also show an embodiment of the baby stroller 14. The baby stroller 14 includes a frame 50 including an outer frame 54, inner frame 56, and base 58. The base 58 includes one or more bars or slats 60 that extend across the bottom of the stroller. The carseat or baby carrier is placed on and supported by these bars 60. The carseat fits within the inner frame 56, which holds the carseat in place and prevents it from moving forward, back, or side to side. The inner frame 56 can receive various different carseats or car carriers from different manufacturers (such as, for example, carseat 80 in FIG. 6) and is thus compatible with many different products. A strap 62 is also provided to further secure the carseat in place. In this embodiment the strap 62 is connected at both ends to the base 58, and is intended to be wrapped over the carseat and adjusted to size. The strap 62 and/or the base 58 may also include hook and loop fasteners or other mechanical fasteners to secure the carseat in place.

The stroller frame 50 also includes an outer frame 54 for additional protection and rigidity. A handle 64 is also provided at the back end of the stroller in case the user wants to push the stroller from behind. The stroller also includes two rear wheels 66.

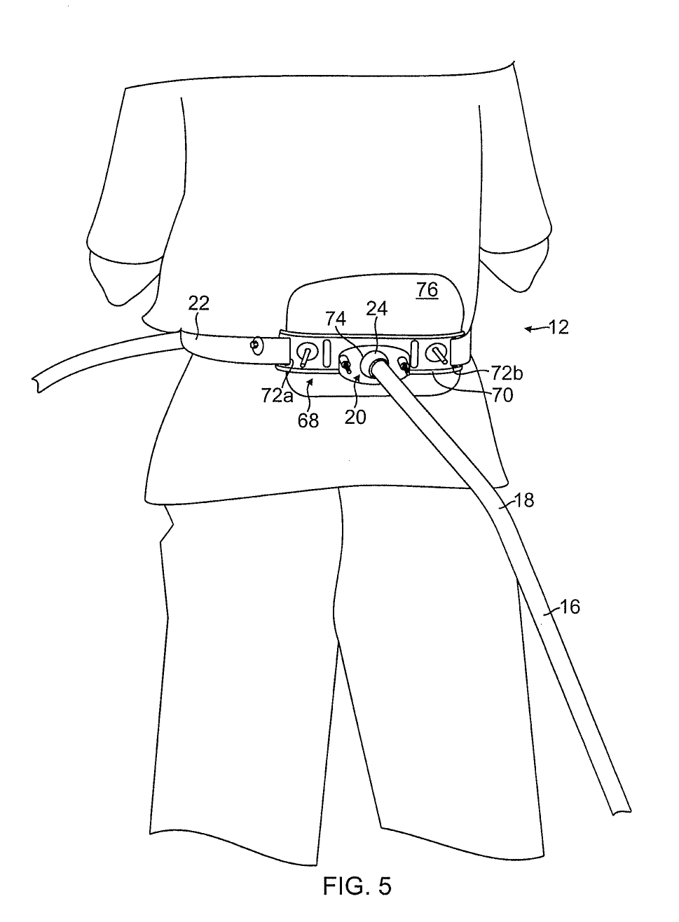

An embodiment of the attachment of the drawbar 16 to the adult user is shown in FIG. 5. A waist harness 12 is provided to attach to the user's waist, leaving the user's hands free. The waist harness 12 includes a belt or strap 22 that wraps around the user's waist and can be adjusted to the correct size, like a seatbelt or belt. The harness 12 also includes a back brace 68 that rests against the user's back and connects to the drawbar 16 at the swivel joint 20. The user can operate the stroller hands-free, pulling the stroller from in front of the stroller.

The back brace 68 includes a main plate or bracket 70 that includes slots 72a, 72b for attachment to the strap 22, and that includes a socket 74 for receiving the ball 24 of the drawbar 16. The slots 72a, 72b receive ends of the strap 22. The socket 74 receives the ball 24 and enables the ball to pivot about a horizontal axis (pivoting up and down, in a vertical direction) and about a vertical axis (pivoting right and left, in a horizontal direction). The ball and socket or swivel joint 20 thus enables the user to move flexibly while carrying the rigid drawbar 16 behind the user.

The harness 12 also includes a soft pad 76 mounted on the inside surface of the bracket 70 for user comfort. The soft pad 76 may be, for example, a foam or rubber pad, or similar material.

The strap 22 passes through the slots 72a, 72b in the bracket 70. The strap 22 can simply be looped around these slots at either end to the bracket 70, as shown, or it can be passed through a first slot, over the pad 76, and through the second slot, to further secure the pad 76 to the bracket 70.

An alternative embodiment of a jogging stroller 200 is shown in FIG. 6. In this embodiment, the drawbar 16 is mounted to the stroller 14 at a joint 26 that allows for rotation about only one axis, rather than two, as shown in FIGS. 3-4. In FIG. 6, the drawbar 16 is attached to the stroller 14 at hinge 26. The hinge plate 28 is fixed to the stroller 14, and the hinge 26 enables the drawbar to move up and down, pivoting about a horizontal axis 42. The hinge 26 is attached to the stroller 14 behind the front wheel 32. The front wheel can pivot independently of the orientation of the drawbar 16, in order to steer the stroller 14. Thus, as the user moves forward and pulls the drawbar 16, the front wheel 32 will pivot as necessary to follow.

In one embodiment, the drawbar 16 can fold back toward the stroller 14 for compact storage. The drawbar itself may be made of one piece or several pieces that fit together.

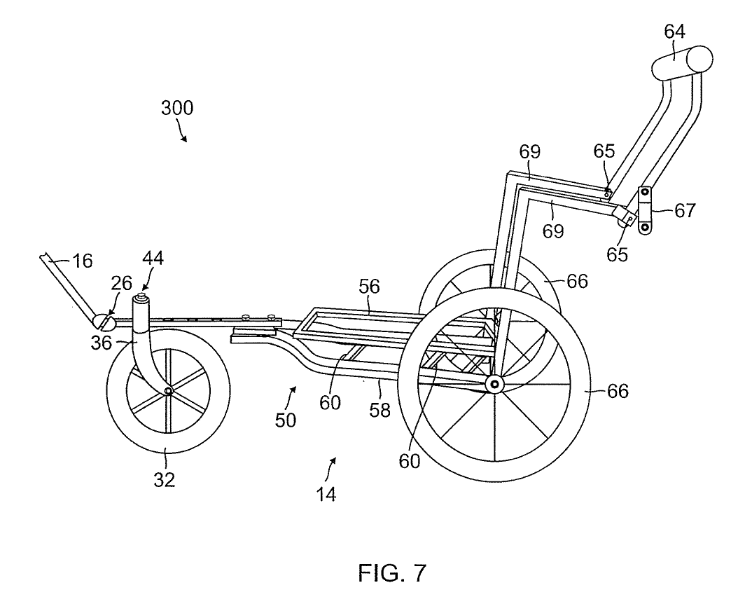

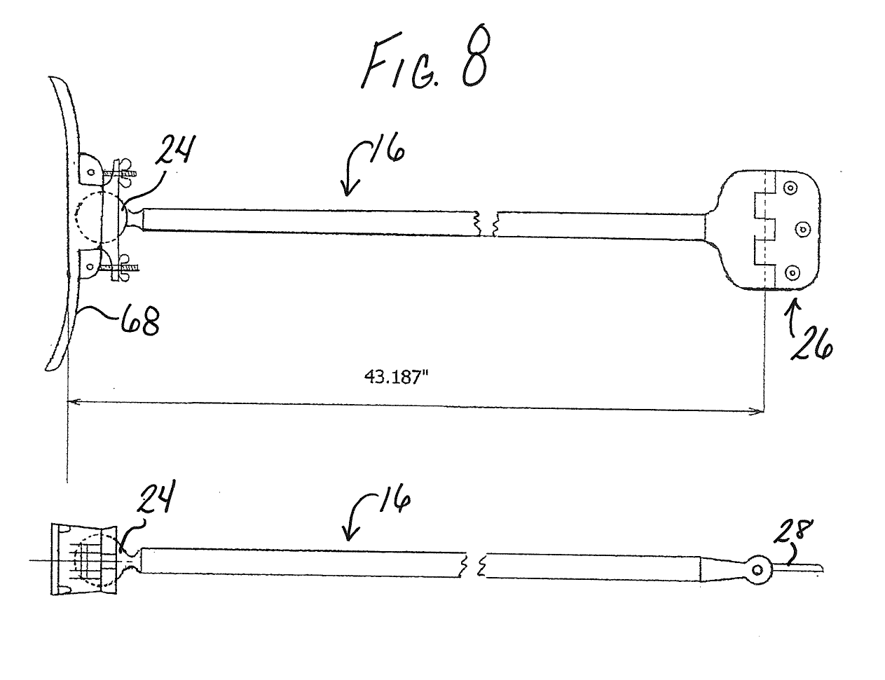

In one embodiment, the stroller is provided without an outer frame 58. That is, the outer frame 58 is optional, as shown for example in FIG. 7. FIG. 7 shows a jogging stroller 300 according to an embodiment of the invention. The jogging stroller 300 includes a stroller frame 50 including a base 58 and an inner frame 56. The base 58 includes cross-beams or struts 60 on which the childseat or carseat is placed. A seatbelt or strap (not shown) is passed across the carseat and attaches to the inner frame 56. In this embodiment, the outer frame 58 is not included. Also, in this embodiment, the handle 64 can be pivoted about pivot points 65 between an extended position and a stowed position. This allows the handle 64 to be extended (rotated clockwise in FIG. 7) for use, or stowed (rotated counter-clockwise in FIG. 7) for compact storage of the jogging stroller. Optionally, the handle 64 also includes a locking clip 67 for locking the handle into the stowed position. When the handle 64 is rotated into the stowed position, the locking clip is attached to the upper crossbar 69 to lock the handle to the crossbar. In one embodiment, the locking clip may also be used to lock the handle into the extended position.

During use, a child carseat is placed on the struts 60 of the base 58, and strapped to the inner frame 56. Instead of a child carseat, other items can be strapped into the stroller frame 50, such as baskets, groceries, or other items that the user desires to move with the stroller.

In one embodiment, the drawbar 16 and the stroller frame 50 are made of aluminum or steel tubing with a diameter of approximately ¼ inch.

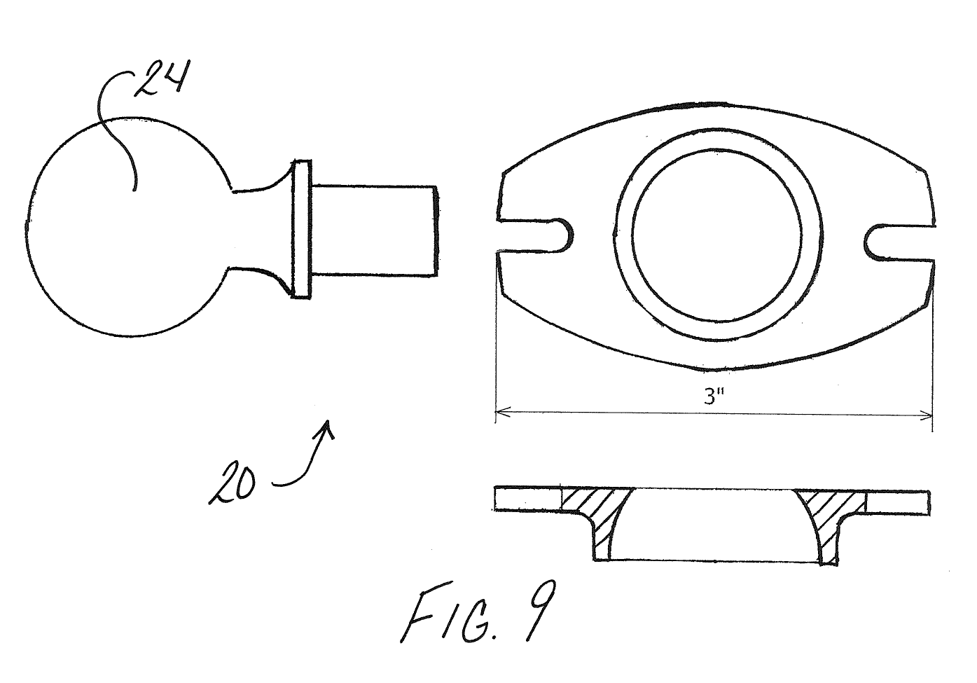

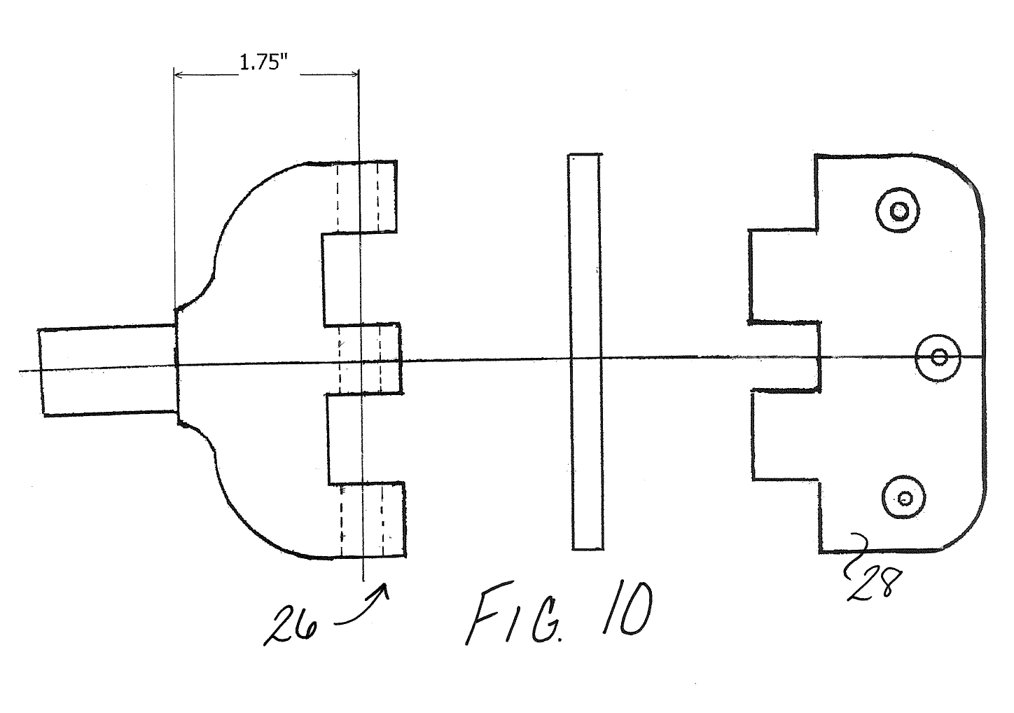

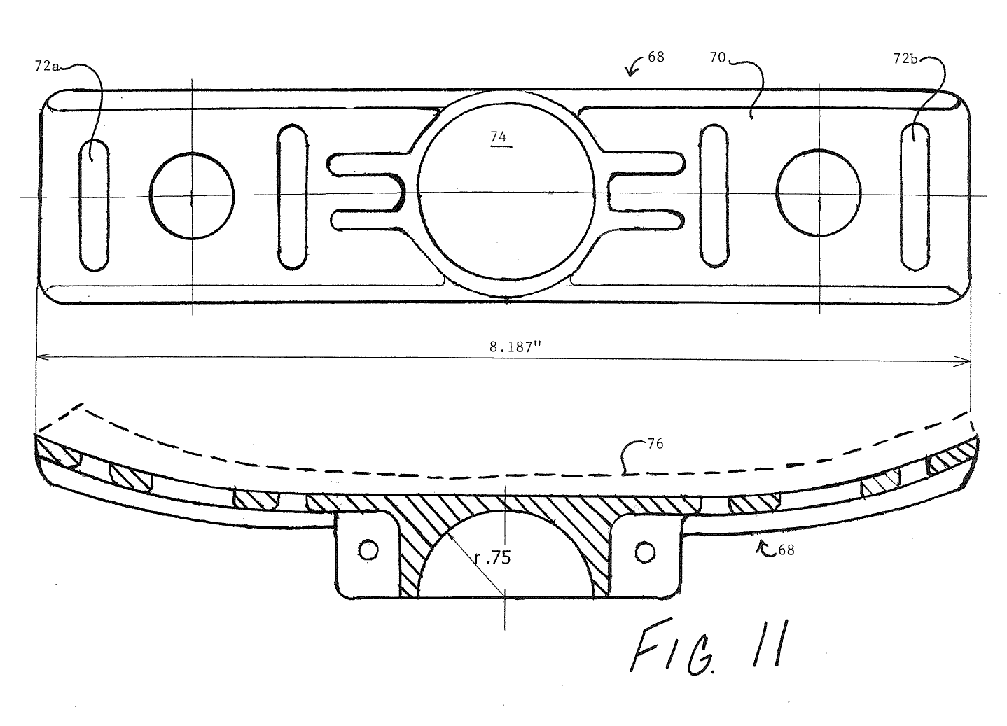

Additional detailed drawings of the drawbar, ball and socket joint, hinge joint, and back brace are shown in FIGS. 8-11. FIG. 8 shows the draw bar, attached to the back brace and hinge assembly. FIG. 9 shows the ball casting and bracket casting for the swivel joint 20. FIG. 10 shows the hinge assembly 26, with hinge plate 28. FIG. 11 shows the back brace 68, with foam padding 76.

Although the present invention has been described and illustrated in respect to exemplary embodiments, it is to be understood that it is not to be so limited, and changes and modifications may be made therein which are within the full intended scope of this invention as hereinafter claimed. For example, the stroller frame can take various shapes and sizes, and the drawbar can be adjusted according to the size of the stroller and the user. The number and position of the wheels on the stroller can also vary.

What is claimed is:

1. A jogging stroller comprising:
a stroller having a frame dimensioned to receive a baby carrier or carseat;
a drawbar mounted to the stroller by a first joint allowing at least one axis of rotation; and
a harness mounted to a front end of the drawbar by a second joint allowing at least two axes of rotation.

2. The jogging stroller of claim 1, wherein the second joint comprises a ball and socket joint.

3. The jogging stroller of claim 1, wherein the first joint comprises a hinge.

4. The jogging stroller of claim 1, wherein the drawbar is further mounted to the stroller by a third joint that allows rotation about a different axis of rotation than the first joint.

5. The jogging stroller of claim 4, wherein the first joint comprises a hinge and the third joint comprises a vertical bearing.

6. The jogging stroller of claim 1, wherein the first joint allows at least two axes of rotation.

7. The jogging stroller of claim 6, wherein the first joint comprises a universal joint.

8. The jogging stroller of claim 1, further comprising a handle, and wherein the handle is rotatable between a stowed position and an extended position.

9. The jogging stroller of claim 8, further comprising a lock for securing the handle into the stowed position.

10. The jogging stroller of claim 1, wherein the frame comprises a base for supporting a baby carrier or carseat and comprises an inner frame, and wherein the jogging stroller further comprises a strap for securing a baby carrier or carseat to the inner frame.

11. A jogging stroller comprising:
a frame dimensioned to receive a baby carrier or carseat;
first and second rear wheels supporting the frame;
a front wheel coupled to the frame by a vertical bearing allowing rotation of the front wheel with respect to the frame about a vertical axis;
a drawbar coupled to the frame by a hinge allowing rotation of the drawbar with respect to the frame about a horizontal axis; and
a harness mounted to a front end of the drawbar by a swivel joint.

12. The jogging stroller of claim 11, wherein the hinge connects the drawbar to the front wheel, such that the drawbar and the front wheel rotate together about the vertical axis of the vertical bearing.

13. The jogging stroller of claim 11, wherein the hinge is connected to the frame independently of the front wheel, such that the front wheel rotates about the vertical axis of the vertical bearing independently of the drawbar.
